(19) United States
(12) Patent Application Publication
(10) Pub. No.: US 2009/0094289 A1
(43) Pub. Date: Apr. 9, 2009

(54) METHOD, APPARATUS AND COMPUTER PROGRAM PRODUCT FOR MULTIPLE BUFFERING FOR SEARCH APPLICATION

(75) Inventors: Yingen Xiong, Mountain View, CA (US); Xianglin Wang, Santa Clara, CA (US); Matthias Jacob, London (GB); Jiang Gao, Sunnyvale, CA (US); Philipp Schloter, San Francisco, CA (US); Kari Pulli, Palo Alto, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/868,178

(22) Filed: Oct. 5, 2007

(51) Int. Cl. G06F 12/00

(52) U.S. Cl. 707/200

(57) ABSTRACT

A method, apparatus and computer program product are provided for facilitating a fast and efficient search. The apparatus may include a processor configured to receive and buffer a dataset based on the current location of a user, in a first buffer; receive and buffer another dataset based on the current location of the user and the direction of movement of the user, in a second buffer; search the dataset, based on the current location of the user, to identify an object from an image; and update buffers based on a change in location of the user, wherein updating buffers includes associating the second buffer with a current location and receive and buffer a dataset, based on the current location of the user and the direction of movement of the user, in the first buffer.

### TECHNOLOGICAL FIELD

Embodiments of the present invention relate generally to content retrieval technology and, more particularly, relate to a method, apparatus and computer program product for database management and data buffering for search applications.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to provision of information retrieval in networks. For example, information such as audio, video, image content, text, data, etc., may be made available for retrieval between different entities using various communication networks. Accordingly, devices associated with each of the different entities may be placed in communication with each other to locate and affect a transfer of the information. In particular, mechanisms have been developed to enable devices such as mobile terminals to conduct searches for information or content related to a particular query or keyword.

Text based searches typically involve the use of a search engine that is configured to retrieve results based on query terms inputted by a user. However, due to linguistic challenges such as words having multiple meanings, the quality of search results may not be consistently high. Additionally, data sources searched may not have information on a particular topic for which the search is being conducted.

Visual search functions such as, for example, mobile visual search functions performed on a mobile terminal, may leverage large visual databases using image matching to compare a query or input image with images in the visual databases. Image matching may tell how close the input image is to images in the visual database. The top matches (e.g., the most relevant images) may then be presented to the user by being visualized on a display of the mobile terminal. Context information associated with the image may then be provided. Accordingly, simply by pointing a camera of a mobile terminal toward a particular object, the user can potentially get context information associated with the particular object based upon the context information associated with the best matches.

However, a problem associated with visual searches may be that the large visual databases that are needed for employment of such search techniques may require relatively large numbers of source images for feature comparisons. Furthermore, in instances in which the search is to be performed by a mobile terminal, the mobile device may be limited in terms of computation power and memory size. As such, a typical search database can only provide adequate coverage for searches that fall within particular areas in which the search database has a sufficiently large number of source images. There are different ways to enable database access during the searching process. One method currently implemented is to load the whole database into the memory of a mobile device before performing the search. Unfortunately, this method may require an excessive amount of memory, thus increasing the size and complexity of the mobile device. Furthermore, the computational complexity of the search is increased by performing an exhaustive search in a huge database, thus increasing the time required to obtain the search results. Another method currently implemented is storing the database on a server wherein the database is structured into smaller datasets according to certain search criteria, such as location data, including longitude/latitude, altitude or GPS location data. As such, different datasets may be created for data associated with different locations. Instead of the whole database, datasets are transferred into memory of the mobile device, one-by-one only when they are needed. The shortcoming of this method includes switching from one dataset to another as the search criteria is changed. In this instance, prior to performing the search with different search criteria, the new dataset must be identified and downloaded. This process not only delays the search, but is also dependent upon network access and availability.

Accordingly, it may be advantageous to provide an improved mechanism for switching from one dataset to another as the search criteria is changed, thereby potentially increasing the speed with which a search is conducted and the reliability in terms of the accessibility of the datasets.

### BRIEF SUMMARY

A method, apparatus and computer program product are therefore provided to provide an improved fast and efficient search by performing an efficient database management and data buffering for search applications. In particular, a method, apparatus and computer program product are provided that leverage the use of location information and visual search characteristics to conduct a visual based search in a more efficient and flexible manner. In this regard, for example, visual based searching may be enhanced by the incorporation of location information into the organization of databases, wherein the most relevant parts of the vast database (datasets) may be located locally in the mobile terminal so as to provide a local search within the mobile terminal. As such, the datasets are updated depending on the change in location of the mobile terminal and the direction of the movement of the mobile terminal. Accordingly, the efficiency of image content retrieval may be increased and content management, navigation, tourism, and entertainment functions for electronic devices such as mobile terminals may be improved.

In one exemplary embodiment, a method for an efficient database management and data buffering for search applications is provided. The method may include receiving and buffering a dataset based on the current location of a user, in a first buffer; receiving and buffering another dataset based on the current location of the user and the direction of movement of the user, in a second buffer; searching the dataset, based on the current location of the user, to identify an object from an image; and updating buffers based on a change in location of the user. For example, in instances in which the current location of the user changes to be within the dataset, in the second buffer, updating the buffers may include associating the second buffer with the current location and receiving and buffering a data set based on the current location of the user and the direction of the movement of the user, in the first buffer, thereby overwriting the first dataset.

In another exemplary embodiment, a computer readable medium storing instructions capable of being executable by a computer for an efficient database management and data buffering for search applications is provided. The instructions comprising instructions for receiving and buffering a dataset based on current location of a user, in a first buffer; instructions for receiving and buffering at least another dataset based on the current location of the user and direction of movement of the user, in a second buffer; instructions for searching the dataset, based on the current location of the user, to identify an object from an image; and instructions for updating buffers based on a change in location of the user. For example, in instances in which the current location of the user changes to be within the dataset, in the second buffer, the instructions for updating the buffers may include instructions for associating the second buffer with the current location and instructions for receiving and buffering a dataset based on the current location of the user and the direction of the movement of the user, in the first buffer.

In another exemplary embodiment, an apparatus for providing an efficient database management and data buffering for search applications is provided. The apparatus may include a processor configured to receive and buffer a dataset based on current location of a user, in a first buffer; receive and buffer another dataset based on the current location of the user and the direction of movement of the user, in a second buffer; search the dataset, based on the current location of the user, to identify an object from an image; and update buffers based on a change in location of the user. For example, in instances in which the current location of the user changes to be within the dataset, in the second buffer, the processor may be configured to associate the second buffer with the current location and to receive and buffer a dataset based on the current location of the user and the direction of the movement of the user, in the first buffer.

Embodiments of the invention may provide a method, apparatus and computer program product for employment in devices to enhance content retrieval such as by visual searching. As a result, for example, mobile terminals and other electronic devices may benefit from an ability to perform content retrieval in an efficient manner and provide results to the user in an intelligible and useful manner with a reduced reliance upon text entry.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a database structured into datasets according to an exemplary embodiment of the present invention; and

FIG. 4 is a flowchart according to an exemplary method for providing double buffering of datasets utilized in a search.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

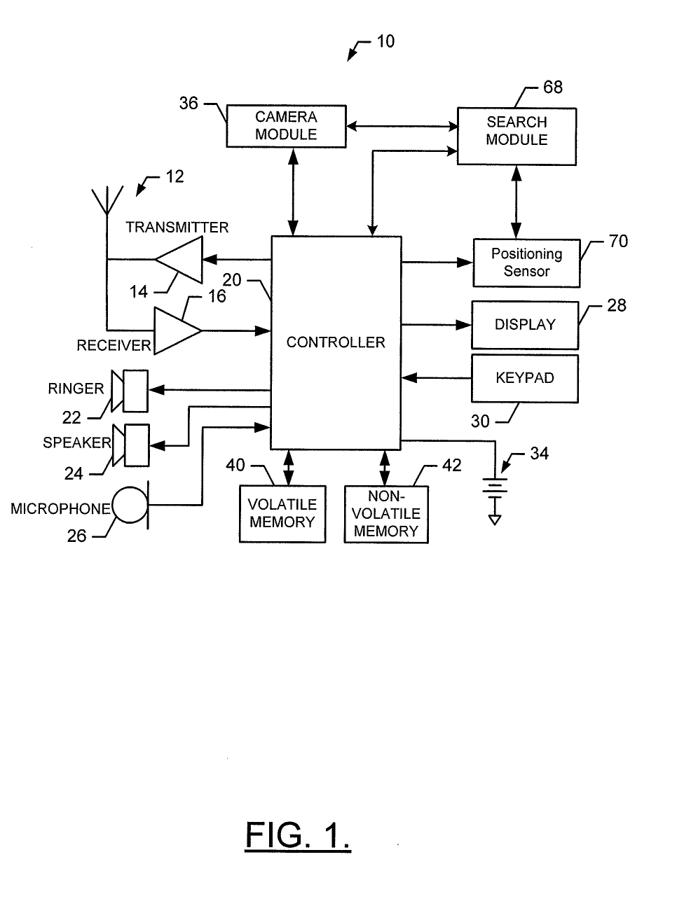

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the apparatus such as the controller 20 includes means, such as circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and/or soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing element, such as a camera, video and/or audio module, in communication with the controller 20. The media capturing element may be any means for capturing an image, video and/or audio for storage, display or transmission. For example, the camera module 36 may include a digital camera capable of forming a digital image file from an object in view, a captured image or a video stream from recorded video data. The camera module 36 may be able to capture an image, read or detect bar codes, as well as other code-based data, OCR data and the like. As such, the camera module 36 includes all hardware, such as a lens or other optical component(s), memory devices, and software necessary for creating and storing a digital image file from a captured image. Alternatively, the camera module 36 may include only the hardware needed to view an image or video stream while memory devices 40, 42, including cache memory, buffers of the mobile terminal 10 store instructions for execution by the controller 20 in the form of software necessary to create a digital image file from a captured and stored image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format.

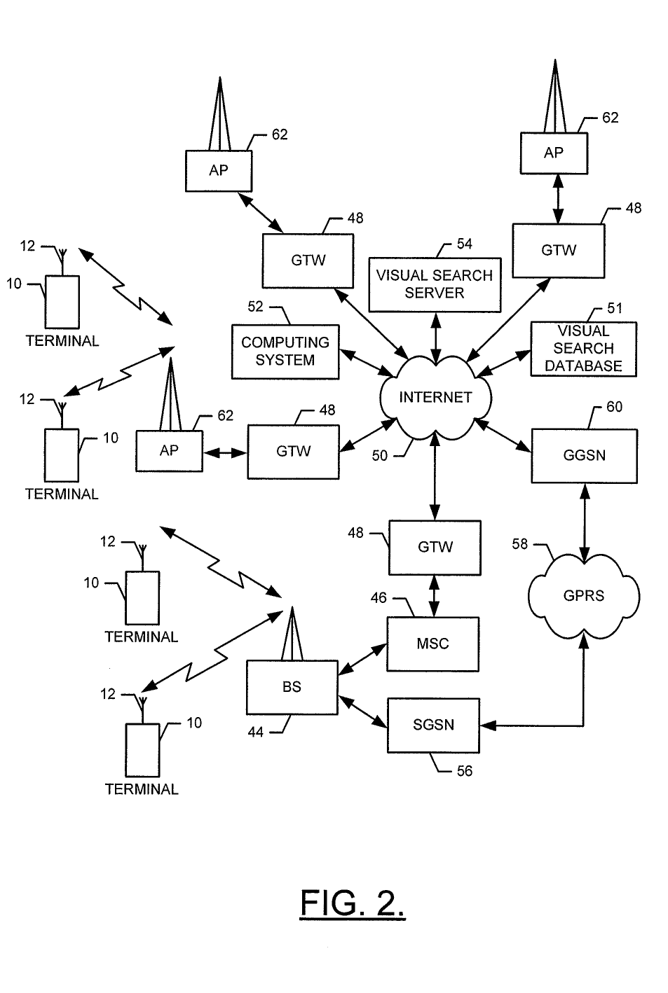

The mobile terminal 10 may further include a positioning sensor 70, such as a global positioning system (GPS) module in communication with the controller 20. The positioning sensor 70 may be any means, device or circuitry for locating the position of the mobile terminal 10. Additionally, the positioning sensor 70 may be any means for locating the position of a point-of-interest (POI), in images captured by the camera module 36, such as for example, shops, bookstores, restaurants, coffee shops, department stores and other businesses and the like. As such, points-of-interest as used herein may include any entity of interest to a user, such as products and other objects and the like. The positioning sensor 70 may include all hardware for locating the position of a mobile terminal or a POI in an image. Alternatively or additionally, the positioning sensor 70 may utilize a memory device(s) 40, 42 of the mobile terminal 10 to store instructions for execution by the controller 20 in the form of software necessary to determine the position of the mobile terminal or an image of a POI. Although the positioning sensor 70 of this example may be a GPS module, the positioning sensor 70 may include or otherwise alternatively be embodied as, for example, an assisted global positioning system (Assisted-GPS) sensor, or a positioning client, which may be in communication with a network device to receive and/or transmit information for use in determining a position of the mobile terminal 10. In this regard, the position of the mobile terminal 10 may be determined by GPS, as described above, cell ID, signal triangulation, or other mechanisms as well. In one exemplary embodiment, the positioning sensor 70 includes a pedometer or inertial sensor. As such, the positioning sensor 70 may be capable of determining a location of the mobile terminal 10, such as, for example, longitudinal and latitudinal directions of the mobile terminal 10, or a position relative to a reference point such as a destination or start point. Information from the positioning sensor 70 may then be communicated to a memory of the mobile terminal 10 or to another memory device to be stored as a position history or location information. Additionally, the positioning sensor 70 may be capable of utilizing the controller 20 to transmit/receive, via the transmitter 14/receiver 16, locational information such as the position of the mobile terminal 10 and a position of one or more POIs to a server such as, for example, a visual search server 51 and/or a visual search database 53 (see FIG. 2), described more fully below.

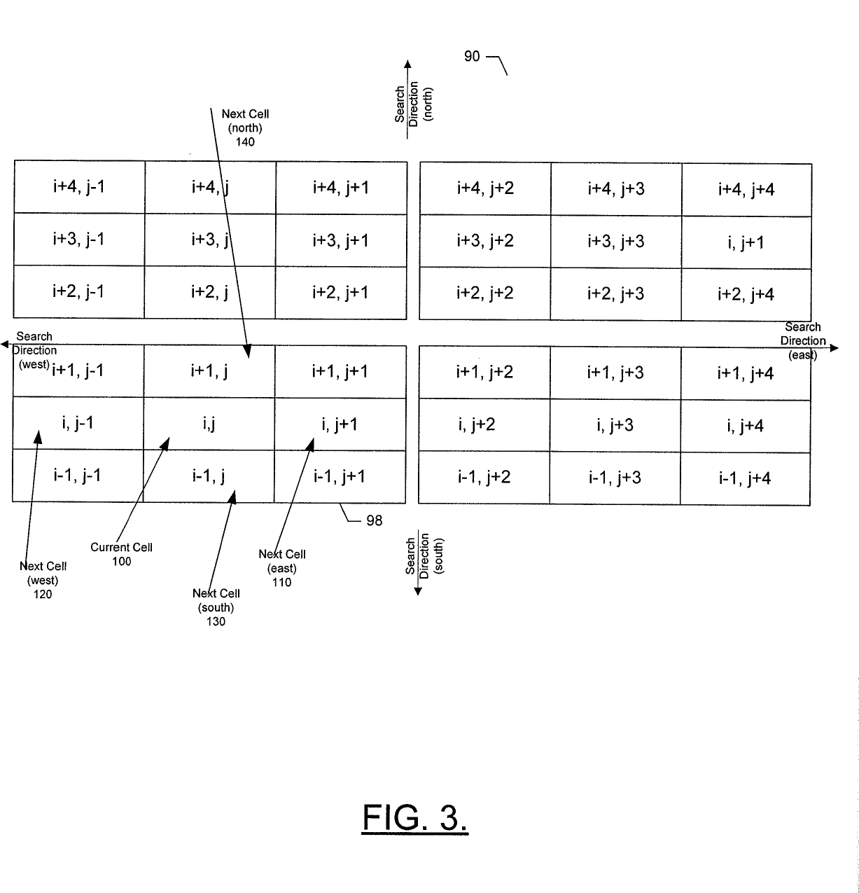

The mobile terminal 10 may also include a visual search client 68 (e.g., a unified mobile visual search/mapping client). The visual search client 68 may be any means, device or circuitry embodied in hardware, software, or a combination of hardware and software that is capable of processing a query (e.g., an image or video clip) received from the camera module 36 and for providing results including images having a degree of similarity (that match) to the query. For example, the visual search client 68 may be configured for recognizing (through conducting a visual search based on the query image for similar images within the datasets (see FIG. 3) stored in the memory devices 40, 42) objects and/or points-of-interest when the mobile terminal 10 is pointed at the objects and/or POIs or when the objects and/or POIs are in the line of sight of the camera module 36 or when the objects and/or POIs are captured in an image by the camera module 36.

The mobile terminal 10 may further be equipped with memory. For example, the mobile terminal 10 may include volatile memory 40, such as volatile Random Access Memory (RAM) including a cache area or buffers for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like. The memories can store any of a number of pieces of information, and data, used by the mobile terminal 10 to implement the functions of the mobile terminal 10 and further according to the exemplary embodiment of the present invention implement visual mobile search applications. In an exemplary embodiment of the present invention the mobile terminal 10 may include at least two buffers for storing datasets (see FIG. 3), received from the visual search database 53 (See FIG. 2), so as to facilitate a visual search which may provide results including images having a degree of similarity (that match) to the query.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52, origin server 54, the visual search server 51, the visual search database 53, and/or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, visual search server 51, visual search database 53, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or ultra wideband (UWB) techniques such as IEEE 802.15 and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention. Furthermore, as will be appreciated by one of ordinary skill in the art, the visual search server 51, computing system 52, visual search database 53, and the origin server 54 may be distributed components (devices) interconnected to one another as is disclosed in FIG. 2 or they may be a single component (device) comprising the functionality of each of the distributed devices and may be referred to as a “server”, which term is intended to encompass a wide variety of computing devices.

As will be appreciated, by directly or indirectly connecting the mobile terminals 10 and the computing system 52, the origin server 54, the visual search server 51, the visual search database 53 and/or any of a number of other devices, to the Internet 50, the mobile terminals 10 can communicate with one another, the computing system 52, the origin server 54, the visual search server 51, the visual search database 53, etc., to thereby carry out various functions of the mobile terminals 10, such as to transmit data, content or the like to, and/or receive content, data or the like from, the computing system 52, the origin server 54, the visual search server 51, and/or the visual search database 53, etc. The visual search server 51, for example, may be embodied as one or more other servers such as, for example, a visual map server that may provide map data relating to a geographical area of one or more mobile terminals 10 or one or more points-of-interest (POI) or a POI server that may store data regarding the geographic location of one or more POI and may store data pertaining to various points-of-interest including but not limited to location of a POI, category of a POI, (e.g., coffee shops or restaurants, sporting venue, concerts, etc.) product information relative to a POI, and the like.

Although not shown in FIG. 2, in addition to or in lieu of coupling the mobile terminal 10 to computing systems 52 and/or the visual search server 51 and visual search database 53 across the Internet 50, the mobile terminal 10 and computing system 52 and/or the visual search server 51 and visual search database 53 may be coupled to one another and communicate in accordance with, for example, RF, BT, IrDA or any of a number of different wireline or wireless communication techniques, including LAN, WLAN, WiMAX, UWB techniques and/or the like. One or more of the computing system 52, the visual search server 51 and visual search database 53 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing system 52, the visual search server 51 and the visual search database 53, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content such as image content, location information and/or POI information may be communicated over the system of FIG. 2 between a mobile terminal, which may be similar to the mobile terminal 10 of FIG. 1 and a network device of the system of FIG. 2, or between mobile terminals. For example, a database may store the content at a network device of the system of FIG. 2, and may transmit, depending on the location of the mobile device, a particular dataset of the database, to the mobile terminal 10 which may desire to search, in the stored datasets, for a particular type of content. However, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, or may be resident on a network device or other device accessible to the communication device.

FIG. 3 illustrates a block diagram of a database structured into datasets according to an exemplary embodiment of the present invention. The database of FIG. 3 will be described, for purposes of example, in connection with the mobile terminal 10 of FIG. 1. However, it should be noted that the database of FIG. 3 may also be employed in connection with a variety of other devices, and therefore, embodiments of the present invention should not be limited to application on devices such as the mobile terminal 10 of FIG. 1. It should also be noted, that while FIG. 3 illustrates one example of a configuration of a database for providing an improved visual search on a mobile device from a vast database, numerous other configurations may also be used to implement embodiments of the present invention.

Referring now to FIG. 3, a structured database 90 is depicted which is stored on a server (see FIG. 2), and which is designed for visual search applications and, in particular for mobile visual search applications. The database can include various different types of content, such as images, videos, data used for matching purpose and other type of information such as location related, etc. In one embodiment, however, each data record generally includes or is associated with a location or other position information. For example, the content of the data record may include reference to a location, such as an address, a state, an area code, a zip code or the like, or the data record may be associated with metadata that provides similar location or position information.

The whole database 90 may be structured into a plurality of smaller cells 100, 110, 120, 130, 140, each comprising a dataset, based on certain search criteria. The cells may be of various shapes and sizes, such as rectangular (as shown in FIG. 3), circular or polygonal, e.g., hexagonal. It should be noted that FIG. 3 illustrates only one example of the configuration of the cells. For each cell, a neighborhood area 98 centered with the cell is defined. The shape of the neighborhood area 98 can be of any shape, e.g. circular or rectangular, etc. Basically, the neighborhood 98 can be determined as the area in which object is visible from the current cell 100. Images and related information such as location data captured in the neighborhood area 98 are used to build a dataset for the cell. In this case, as long as the dataset of the current cell 100 is available on mobile terminal, the user can search any object visible from the current cell. The location data are not limited to any specific kind, but rather include a wide range such as longitude/latitude, longitude/latitude/altitude triplets, location indicators, cellIDs, or any other location descriptor. As a result, a dataset can be constructed for every cell in the grid.

Based on the location of the mobile terminal 10 the appropriate datasets are transferred, from the server, to the memory 40, 42 of the mobile terminal. The mobile terminal 10 receives and stores the datasets transmitted by the server. The datasets that are transferred from the server to the mobile terminal include the current cell and at least one cell proximate to but displaced in the direction of motion of the mobile terminal from the current cell. While one embodiment will be hereinafter described in which both the current cell and a single cell (termed the “next cell”) adjacent to the current cell and positioned along the direction of motion of the mobile terminal are transmitted, multiple cells aligned along the direction of motion of the mobile terminal could be transmitted if desired. Notably, however, other cells, such as cells that are not along the current direction of motion of the mobile terminal or are further removed or distant from the current cell are not transmitted, thereby conserving bandwidth, conserving memory at the mobile terminal and limiting the data that must be searched by the mobile terminal, thereby permitting the search to be performed by a mobile terminal instead of a server.

For example, if the mobile terminal 10 is located in the current cell 100 and moving in the direction from west to east the mobile terminal will store the current cell 100 and the next cell 110. If the mobile terminal is, instead, moving north, the next cell is cell 140; if moving south, the next cell is cell 130; and if moving west, the next cell is cell 120. Furthermore, the direction of motion is not limited to horizontal and vertical directions, i.e., east, west, north, south, and may also include moving in northeast, northwest, southeast and southwest directions wherein the corresponding current cell datasets and next cell datasets in the northeast, northwest, southeast and southwest directions, respectively, are transferred to the mobile terminal 10. Additionally, while a database 90 reflective of two-dimensional location data is illustrated and described, the database may be multidimensional, such as three-dimensional with a location defined, for example, by latitude, longitude and altitude.

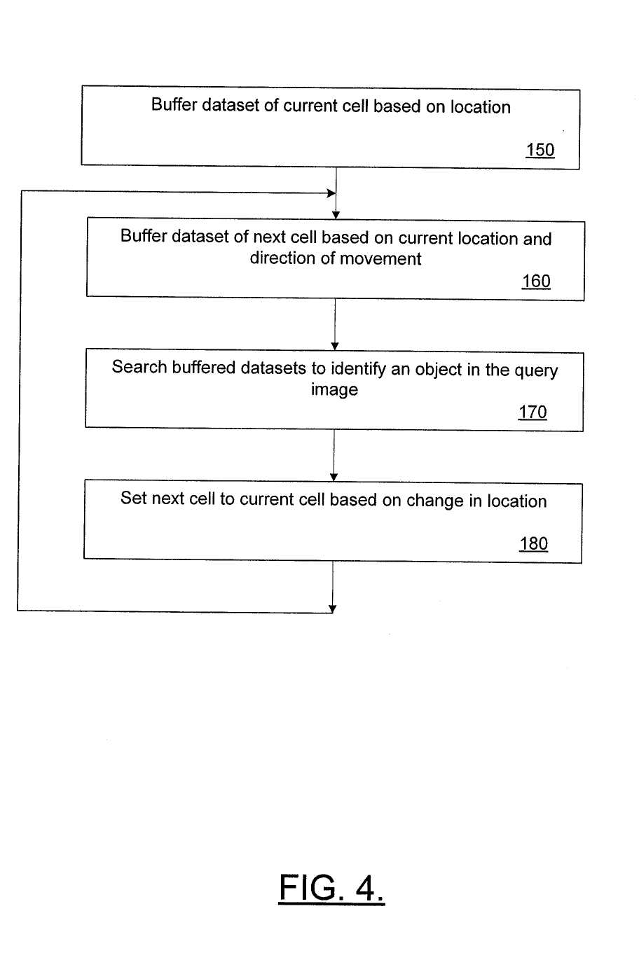

Referring now to FIG. 4, which discloses a flowchart according to an exemplary method for providing multiple buffering for mobile search applications. The mobile terminal 10 may receive from the server and buffer the dataset of the current cell 100 at operation 150 and the dataset of the next cell 110, depending on the direction of the movement of the mobile terminal 10 at operation 160. At operation 170 the mobile terminal 10 may issue or receive a query requesting a visual search for an object included in an image and may then search the datasets of the current cell 100 stored locally by the mobile terminal 10. Based on the location of the mobile terminal 10, as the mobile terminal moves from one cell to the cell previously designated as the next cell, the next cell dataset is set to be the current cell at operation 180 and further the current next cell dataset, based on the current direction of motion of the mobile terminal, is transmitted by the server and is received and buffered by the mobile terminal 10. The process of buffering is preformed in the background, that is, while other applications are executing and without user intervention, so as not to interrupt the normal functioning of the mobile device 10. Furthermore, buffering of cell datasets is not limited to buffering of only the current cell and the next cell, depending on the moving direction of the mobile terminal 10 and the capability of the mobile terminal 10 multiple next cell datasets may be buffered. However, by limiting the search space, the relevant datasets can be all transferred to the mobile terminal and the search may be performed locally, thereby potentially increasing the speed of the search and decreasing its dependence upon network connectivity to perform the search.

In order to determine when the mobile terminal has moved into a location that is outside of the prior current cell and in one of the adjoining cells, such as the prior next cell, either the server can repeatedly poll the mobile terminal for its location or the mobile terminal can repeatedly provide the server with its current location. Alternatively, the mobile terminal can locally store the bounds of the current cell and, as such, may be able to repeatedly compare its location to the bounds of the current cell. If the mobile terminal of this embodiment determines that the mobile terminal has moved into another cell, the mobile terminal can provide its location or the identity of the new cell to the server in conjunction with a request to update the datasets that have been transmitted to and buffered by the mobile terminal.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving and buffering a dataset based on a current location of a user;
receiving and buffering at least another dataset based on the current location of the user and a direction of movement of the user;
searching the dataset, based on the current location of the user, to identify an object from an image; and
updating buffers based on a change in location of the user.

2. The method of claim 1, further comprising buffering the datasets in the background.

3. The method of claim 1, wherein searching the dataset further comprises finding a best match for the object from the image.

4. The method of claim 1, wherein buffering the datasets further comprises buffering the dataset, based on the current location of the user, in a first buffer and buffering the dataset, based on the current location of the user and the direction of movement of the user, in a second buffer.

5. The method of claim 4, wherein updating buffers in instances in which the current location of the user changes to be within the second buffer further comprises:
associating the second buffer with a current location; and
receiving and buffering a dataset based on the current location and the direction of movement of the user, in the first buffer.

6. The method of claim 1, wherein searching the dataset comprises excluding from the search other datasets that are not along the direction of movement of the user.

7. The method of claim 1, wherein the direction of movement includes a change in altitude.

8. A computer readable medium storing instructions capable of being executed by a computer, the instructions comprising:
instructions for receiving and buffering a dataset based on a current location of a user;
instructions for receiving and buffering at least another dataset based on the current location of the user and a direction of movement of the user;
instructions for searching the dataset, based on the current location of the user, to identify an object from an image; and
instructions for updating buffers based on a change in location of the user.

9. The computer readable medium of claim 8, wherein the instructions for buffering the datasets are performed in the background.

10. The computer readable medium of claim 8, wherein the instructions for searching the dataset further comprises instructions for finding a best match for the object from the image.

11. The computer readable medium of claim 8, wherein the instructions for buffering the datasets further comprises instructions for buffering the dataset, based on the current location of the user, in a first buffer and buffering the dataset, based on the current location of the user and the direction of movement of the user, in a second buffer.

12. The computer readable medium of claim 11, wherein the instructions for updating buffers in instances in which the current location of the user changes to be within the second buffer further comprises:
instructions for associating the second buffer with a current location; and
instructions for receiving and buffering a dataset based on the current location of the user and the direction of movement of the user, in the first buffer.

13. The computer readable medium of claim 8, wherein the instructions for searching the dataset comprises excluding from the search other datasets that are not along the direction of movement of the user.

14. The computer readable medium of claim 8, wherein the direction of movement includes a change in altitude.

15. An apparatus comprising a processor configured to:
buffer a dataset based on a current location of a user;
buffer another dataset based on the current location of the user and a direction of movement of the user;
search the dataset, based on the current location of the user, to identify an object from an image; and
update buffers based on a change in location of the user.

16. The apparatus of claim 15, wherein the processor is further configured to buffer the datasets in the background.

17. The apparatus of claim 15, wherein the processor is further configured to search the dataset by finding a best match for the object from the image.

18. The apparatus of claim 15, wherein the processor is further configured to buffer the dataset, based on the current location of the user, in a first buffer and the dataset, based on the current location of the user and the direction of the movement of the user, in a second buffer.

19. The apparatus of claim 18, wherein the processor is further configured to update the buffers in instances in which the current location of the user changes to be within the second buffer by:
associating the second buffer with a current location; and
buffering a dataset based on the current location and the direction of movement of the user, in the first buffer.

20. The apparatus of claim 15, wherein the processor is configured to search the dataset, so as to exclude from the search other datasets that are not along the direction of movement of the user.

21. The apparatus of claim 15, wherein the direction of movement includes a change in altitude.

22. An apparatus comprising:
means for receiving and buffering a dataset based on a current location of a user;
means for receiving and buffering another dataset based on the current location of the user and a direction of movement of the user;
means for searching the dataset, based on the current location of the user, to identify an object from an image; and
means for updating buffers based on a change in location of the user.
